(19) United States
(12) Patent Application Publication
(10) Pub. No.: US 2006/0293916 A1
(43) Pub. Date: Dec. 28, 2006

(54) Methods, systems, and computer-readable media for enabling collaborative communication between browser and non-browser components in an advanced patient management system

(76) Inventor: Benjamin L. Somberg, Shoreview, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/158,602

(22) Filed: Jun. 22, 2005

(51) Int. Cl. G06Q 10/00

(52) U.S. Cl. 705/2

(57) ABSTRACT

Embodiments of the invention provide methods, systems, and computer-readable media for enabling collaborative communication between browser and non-browser components in an advanced patient management system. In one embodiment, patient data in the advanced patient management system is selected in a browser component. The browser component may include an Internet web browser which displays the patient data as a web page. A non-browser component is utilized to detect the patient data in the browser component and display the patient data. The non-browser component may be configured as a plug-in software module to the web browser. The non-browser component may further be utilized to modify patient data and display the modified patient data in the browser component. The modified patient data may include settings associated with a patient monitoring device in the advanced patient management system.

### TECHNICAL FIELD

This application relates generally to patient management systems, and particularly, but not by way of limitation, to a computer application program for enabling collaborative communication between browser and non-browser components for displaying patient data utilized in an advanced patient management system.

### BACKGROUND OF THE INVENTION

Management of patients with chronic disease consumes a significant proportion of the total health care expenditure in the United States. Many of these diseases are widely prevalent and have significant annual incidences as well. Heart Failure prevalence alone is estimated at over 5.5 million patients in 2000 with incidence rates of over half a million additional patients annually, resulting in a total health care burden in excess of $20 billion. Heart Failure, like many other chronic diseases such as Asthma, Chronic Obstructive Pulmonary Disease (“COPD”), Chronic Pain, and Epilepsy is event driven, where acute de-compensations result in hospitalization. In addition to causing considerable physical and emotional trauma to the patient and family, event driven hospitalizations consume a majority of the total health care expenditure allocated to the treatment of heart failure.

An interesting fact about the treatment of acute de-compensation is that hospitalization and treatment occurs after the event (de-compensation) has happened. However, most Heart Failure patients exhibit prior non-traumatic symptoms, such as steady weight gain, in the weeks or days prior to the de-compensation. If the attending physician is made aware of these symptoms, it is possible to intervene before the event, at substantially less cost to the patient and the health care system. Intervention is usually in the form of a re-titration of the patient's drug cocktail, reinforcement of the patient's compliance with the prescribed drug regimen, or acute changes to the patient's diet and exercise regimens. Such intervention is usually effective in preventing the de-compensation episode and thus avoiding hospitalization.

In order to provide early detection of symptoms that may signal an increased likelihood of a traumatic medical event, patients may receive implantable medical devices (“IMDs”) that have the ability to measure various body characteristics. For instance, IMDs are currently available that provide direct measurement of electrical cardiac activity, physical motion, temperature, and other clinical parameters. The data collected by these devices is typically retrieved from the device through interrogation.

Some IMDs communicate with a repeater located in the patient's home via a short range wireless communications link. The repeater interrogates the IMD and retrieves the clinical data stored within the IMD. The repeater then establishes a connection with a host computer or patient management system and transmits the clinical data. Conveniently, the host computer may also communicate with or include functionality to function as a web server such that the clinical data received by the repeater is “published” to one or more web pages. The web pages, once published, enable the clinical data to be accessed by a conventional web browser from one or more remote personal computers via the Internet. Thus, these remote personal computers have access to the clinical data without needing a direct connection to the host computer.

While the viewing of clinical data in a web browser via any personal computer over the Internet may be convenient, the programming of IMDs (i.e., changing settings within the devices) is typically done utilizing a dedicated client application residing on a computer as it is may be undesirable to support remote programming in a web environment over an unsecure network, such as the Internet. Therefore, if a physician initially accesses a patient's clinical data via a web browser and determines reprogramming of an IMD is necessary, the physician must then access a separate client application program on his/her computer to effect the necessary programming. This can be extremely inconvenient for the physician who is forced to go back and forth between the web browser and the application program to view and modify clinical data as there is no collaboration between the web browser and the application program.

Therefore, in light of the above, there is a need for a method and system for enabling collaboration between a web browser and an application program such that actions with respect to clinical data in the application program are capable of changing what is displayed in the web browser and vice versa.

### SUMMARY OF THE INVENTION

Embodiments of the present invention solve the above-described problem by providing a method and system for enabling collaborative communication between browser and non-browser components in an advanced patient management system.

According to one illustrative embodiment of the invention, a method is provided for selecting patient data from the advanced patient management system in a browser component, displaying the patient data in a non-browser component, and vice versa. The browser component may include an Internet web browser which displays the patient data as a web page. The non-browser component may include a web browser plug-in module or a client application program. The method may further include modifying the patient data displayed in the non-browser component and displaying the modified patient data in the browser component. The modified patient data may include modified settings associated with a patient monitoring device in the advanced patient management system.

In displaying the patient data in the non-browser component, the method may include detecting the patient data displayed in the browser component, detecting properties belonging to the displayed patient data in the browser component, and displaying the patient data in the non-browser component based on the detected properties. In displaying the patient data in the browser component, the method may include receiving a command from the non-browser component to retrieve and display the selected patient data in the browser component.

Embodiments of the present invention also include a system and a computer-readable medium for enabling collaborative communication between browser and non-browser components in an advanced patient management system. These and various other features as well as advantages, which characterize the present invention, will be apparent from a reading of the following detailed description and a review of the associated drawings.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram illustrating an advanced patient management system utilized in one embodiment of the present invention.

FIG. 2A is a block diagram illustrating the communication between a browser component and a non-browser component of the advanced patient management system of FIG. 1, according to one embodiment of the present invention.

FIG. 2B is a block diagram illustrating the communication between a browser component and a non-browser component of the advanced patient management system of FIG. 1, according to an alternative embodiment of the present invention.

FIGS. 3-4 are flowcharts illustrating methods for enabling collaborative communication between browser and non-browser components in an advanced patient management system according to one embodiment of the present invention.

FIGS. 5-8 are screenshots illustrating the results of the collaborative communication between browser and non-browser components in an advanced patient management system according to one embodiment of the present invention.

### DETAILED DESCRIPTION OF ILLUSTRATIVE EMBODIMENTS OF THE INVENTION

In the following detailed description, reference is made to the accompanying drawings which form a part hereof, and in which is shown by way of illustration specific embodiments or examples. These embodiments may be combined, other embodiments may be utilized, and structural, logical, and electrical changes may be made without departing from the spirit and scope of the present invention. The following detailed description is, therefore, not to be taken in a limiting sense, and the scope of the present invention is defined by the appended claims and their equivalents.

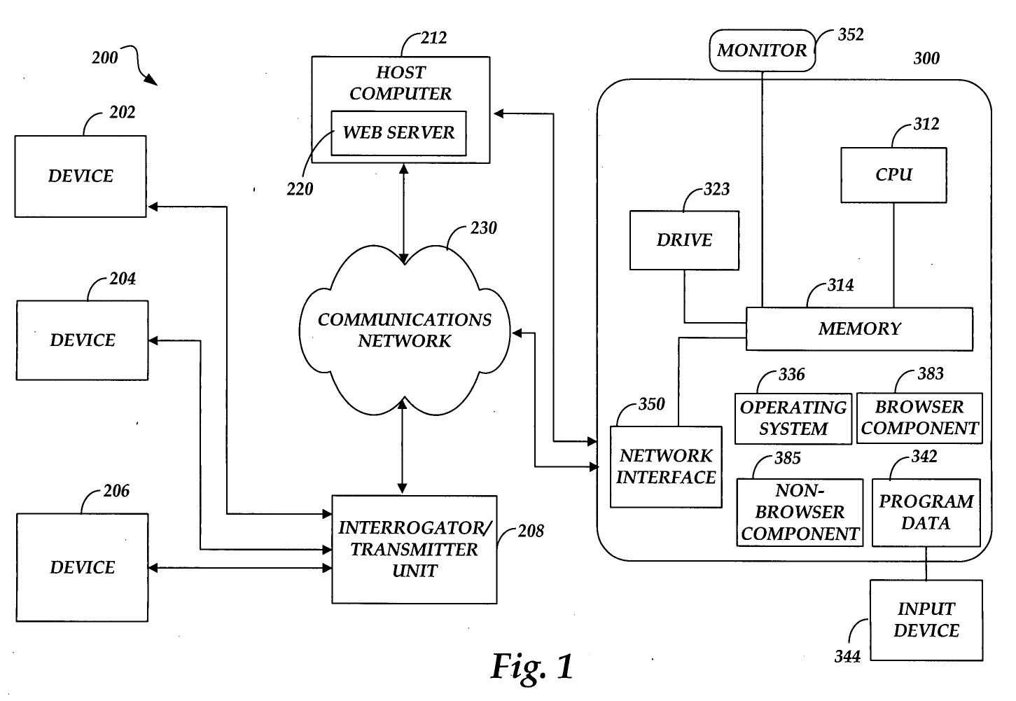

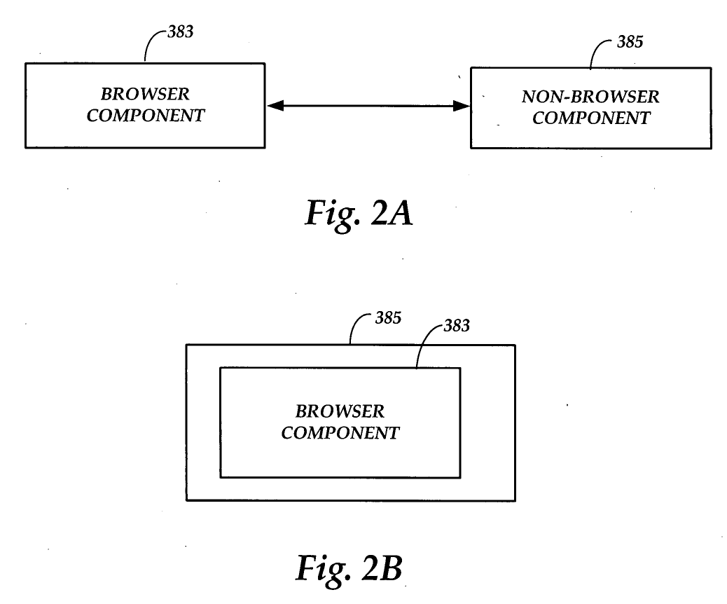

The method and system described herein are described in the context of an advanced patient management system that provides patient management and device management. It should be appreciated that although the embodiments of the invention are described in the context of a patient management system, the embodiments of the invention may be utilized within other operating environments. Additional details regarding the advanced patient management system that provides one operating environment for the embodiments of the invention are provided below with respect to FIG. 1. Additional details regarding the system and method provided herein are provided below with respect to FIGS. 2A-8.

Turning now to FIG. 1, an illustrative advanced patient management system 100 will be described in the context of an illustrative operating environment. As shown in FIG. 1, the advanced patient management system 200 can generally include the following components: one or more devices 202, 204, and 206, one or more interrogator/transceiver units (“ITU”) 208, a communications network 230, a host computer 212, and a personal computer 300.

Each component of the advanced patient management system 200 can communicate over the communications network 230. In the advanced patient management system 200, some components may also communicate directly with one another. For example, the host computer 212 may be configured to communicate directly with the personal computer 300. The various components of the example advanced patient management system 200 illustrated herein are described below.

Devices 202, 204, and 206 can be implantable medical devices (“IMDs”) or external devices that may provide one or more of the following functions with respect to a patient: (1) sensing, (2) data analysis, and (3) therapy. For example, in one embodiment, devices 202, 204, and 206 can be implanted or external devices used to measure a variety of physiological, subjective, and environmental conditions of a patient using electrical, mechanical, and/or chemical means. The devices 202, 204, and 206 can be configured to automatically gather data or can require manual intervention by the patient. The devices 202, 204, and 206 can be configured to store data related to the physiological and/or subjective measurements and/or transmit the data to the communications network 210 using a variety of methods, described in detail below. Although three devices 202, 204, and 206 are illustrated in the example embodiment shown, more or fewer devices may be used for a given patient.

The devices 202, 204, and 206 can be configured to analyze the measured data and act upon the analyzed data. For example, the devices 202, 204, and 206 may be configured to modify therapy or provide alarm indications based on the analysis of the data.

In one embodiment, devices 202, 204, and 206 may also provide therapy. Therapy can be provided automatically or in response to an external communication. Devices 202, 204, and 206 can be programmable in that the characteristics of their sensing (e.g., duration and interval), therapy, or communication can be altered via communication between the devices 202, 204, and 206 and other components of the advanced patient management system 200. Devices 202, 204, and 206 can also perform self-checks or be interrogated by the communications network 230 to verify that the devices are functioning properly.

Devices 202, 204, and 206 can also be external devices or devices that are not implanted in the human body, which may be used to measure physiological data. Such devices may include a multitude of devices to measure data relating to the human body, including temperature (e.g., a thermometer), blood pressure (e.g., a sphygmomanometer), blood characteristics (e.g., glucose levels), body weight, physical strength, mental acuity, diet, heart characteristics, and relative geographic position (e.g., a Global Positioning System (“GPS”)).

The ITU 208 in the advanced patient management system 200 is configured to receive data from a device such as devices 202, 204, store the data, and communicate the data between the devices 202, 204, and 206 and the host 212 over the communications network 230. The ITU 208 may also perform one or more of the following functions: (1) data analysis; (2) patient interaction; and (3) patient feedback. The ITU 208 can, periodically or in real-time, interrogate and download into memory clinically relevant patient data from the devices 202, 204, and/or 206. The data may be sent to the ITU 208 by the devices 202, 204, and 206 in real-time or periodically uploaded out of buffers on the devices.

The ITU 208 may be in the form of a small device that is placed in an inconspicuous place within the patient's residence. Alternatively, the ITU may be implemented as part of a commonly used appliance in the patient's residence. For example, the ITU may be integrated with an alarm clock that is positioned near the patient's bed. In another embodiment, the ITU may be implemented as part of the patient's personal computer system. Other embodiments are also possible.

In another embodiment, the ITU 208 may comprise a hand-held device such as a PDA, cellular telephone, or other similar device that is in wireless communication with the devices 202, 204, and 206. The hand-held device may upload the data to the communications network 230 wirelessly. Alternatively, the hand-held device may periodically be placed in a cradle or other similar device that is configured to transmit the data to the communications network 230.

In other embodiments of the advanced patient management system 200, the ITU 208 can be eliminated completely, and the devices 202, 204, and 206 can communicate directly with the communications network 230 and/or host 212. For example, device 202 may include a miniature cellular phone capable of wirelessly uploading clinical data from the device on a periodic basis. This is particularly advantageous for devices that are mobile (e.g., an implanted device in a patient that is traveling). The device 202 can incorporate wireless telecommunications such as cellular, BLUETOOTH, or IEEE 802.11B to communicate with the communications network 230.

In yet another embodiment, the devices 202, 204, and 206 include wires or leads extending from devices 202, 204, and 206 to an area external of the patient to provide a direct physical connection. The external leads can be connected, for example, to the ITU 208 or a similar device to provide communications between the devices 202, 204, and 206 and the other components of the advanced patient management system 200.

In the advanced patient management system 200 the host 212 may include one or more server computers for storing patient data received from the devices 202, 204, and 206 thought the ITU 208. The host 212 may also include identification and contact information (e.g., IP addresses and/or telephone numbers) for the various devices communicating with it, such as the ITU 208. For example, the ITU 208 may be assigned a hard-coded or static identifier (e.g., IP address, telephone number, etc.), which would allow the host 212 to identify which patient's information the host 212 is receiving at a given instant. Alternatively, each device 202, 204, and 206 may be assigned a unique identification number, or a unique patient identification number may be transmitted with each transmission of patient data. The host 212 is also capable of managing a web interface, through web server 220, which can be accessed by patients or caregivers. The information gathered by an implanted device can be periodically or continuously transmitted from the host 212 to a web site, which may be hosted by the web server 220 and which is securely accessible to the caregiver and/or patient, in a timely manner. For example, a patient or physician can access a web page hosted by the web server 220 to view information regarding current patient data gathered from the devices 202, 204, and 206.

The host 212 may also be utilized to communicate with and reconfigure settings for one or more of the devices 202, 204, and 206. For example, if device 202 is part of a cardiac rhythm management system, the host 212 can communicate with the device 202 and reconfigure therapy settings provided by the cardiac rhythm management system based on the data collected from one or more of the devices 202, 204, and 206.

The personal computer 300 in the advanced patient management system 200 can include a central processor unit 312 and a system memory 314. The computer system 300 further includes one or more drives 323 for reading data from and writing data to, as well as an input device 344 such as a keyboard or mouse and a monitor 352 or other type of display device.

A number of program modules may be stored on the drive 323, including an operating system 336, a browser component 383, a non-browser component 385 and program data 342. The browser component 383 may be an existing commercial Internet web browser for opening and viewing web pages (such as the INTERNET EXPLORER browser program marketed by MICROSOFT CORPORATION of Redmond, Wash.). The non-browser component 385 may be a client application program which is utilized to display and modify patient data received from the devices 202, 204, and 206 on the personal computer 300. The non-browser component 385 may also be utilized to view and modify patient data displayed in a web page in the browser component 383. The browser component 383 and the non-browser component 385 will be discussed more fully in the description of FIGS. 2A-2B, below.

The computer system 300 may operate in a networked environment using logical connections to communicate with the communication network 230 or directly to the host 212 via the network interface 350. Those skilled in the art will appreciate that the personal computer 300 may also comprise a hand-held computer such as a personal digital assistant (“PDA”) computer.

Communications network 230 provides for communications between and among the various components of the advanced patient management system 200, such as the devices 202, 204, and 206, host 212, ITU 208, and personal computer 300. The communications network 230 may be, for example, a local area network (“LAN”) or a wide area network (WAN), such as the Internet. A variety of communication methods and protocols may be used to facilitate communication between devices 202, 204, and 206, ITU 208, communications network 210, host 212, and personal compute 300. For example, wired and wireless communications may be used. Wired communication methods may include, for example and without limitation, traditional copper-line communications such as DSL, broadband technologies such as ISDN and cable modems, and fiber optics, while wireless communications may include cellular, satellite, radio frequency (“RF”), infrared, etc.

For any given communication method, a multitude of standard and/or proprietary communication protocols may be used. For example and without limitation, wireless (e.g., radio frequency pulse coding, spread spectrum, direct sequence, time-hopping, frequency hopping, etc.) and other communication protocols (e.g., SMTP, FTP, TCP/IP) may be used. Other proprietary methods and protocols may also be used. Further, a combination of two or more of the communication methods and protocols may also be used.

The various communications between the components of the advanced patient management system 200 may be made securely using several different techniques. For example, encryption and/or tunneling techniques may be used to protect data transmissions. Alternatively, a priority data exchange format and interface that are kept confidential may also be used. Authentication can be implemented using, for example, digital signatures based on a known key structure (e.g., PGP or RSA). Other physical security and authentication measures may also be used, such as security cards and biometric security apparatuses (e.g., retina scans, iris scans, fingerprint scans, veinprint scans, voice, facial geometry recognition, etc.). Conventional security methods such as firewalls may be used to protect information residing on one or more of the storage media of the advanced patient management system 200. Encryption, authentication and verification techniques may also be used to detect and correct data transmission errors.

Communications among the various components of the advanced patient management system 200 may be enhanced using compression techniques to allow large amounts of data to be transmitted efficiently. For example, the devices 202, 204, and 206 may compress the information recorded from the patient prior to transmitting the information to the ITU 208 or directly to the communications network 230. The communication methods and protocols can facilitate periodic and/or real-time delivery of data.

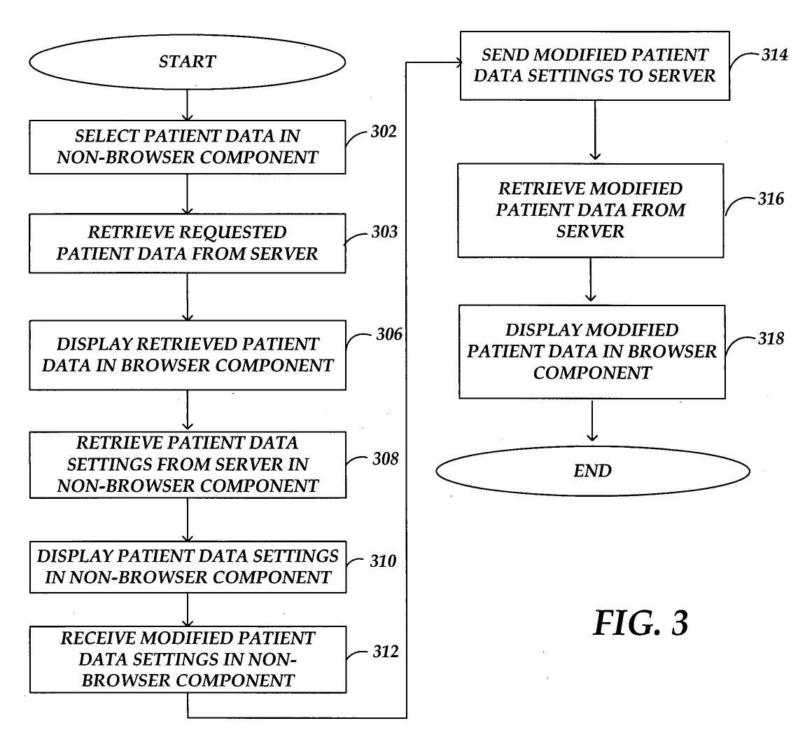

Referring now to FIGS. 2A-2B, block diagrams illustrating the communication between the browser component 383 and the non-browser component 385 in the advanced patient management system discussed above with respect to FIG. 1, will now be described. Turning now to FIG. 2A, the browser component 383 is shown as a separate application in communication with the non-browser component 385 in accordance with an illustrative embodiment of the invention. It should be appreciated that in this embodiment, the non-browser component 385 may be a software “plug-in” module to the browser component 383. As is known to those skilled in the art, a plug-in is a hardware or software module that adds a specific feature or service to a browser. As will be described in greater detail in the description of FIGS. 3-8 below, the non-browser component plug-in may be configured to generate a graphical user interface (“GUI”) within a web page for displaying patient data displayed in the browser component 383. The non-browser component 385 may then be utilized to modify the patient data displayed in the web page. It will be appreciated that in one illustrative embodiment, the browser component 383 may reside on a separate hardware device from the non-browser component 385. For instance, in the advanced patient management system described in FIG. 1, the browser component 383 may reside on the personal computer 300 while the non-browser component 385 may reside on another computing device (not shown) such as a handheld computer. It will be appreciated that in this embodiment, communication between the components may occur over the communication network 230.

It should be appreciated that communication between the browser component 383 and the non-browser component 385 may also be enabled via a bridge between the two components. Those skilled in the art will appreciate that the bridge between the components may be established utilizing a variety of known techniques and software programming languages. Once the bridge is created, properties and events within the browser component 383 may be discerned by the non-browser component 385 through, for example, an application programming interface (“API”). Similarly, the bridge enables the detection of properties (e.g., attributes) and events belonging to a document (i.e., a web page displaying patient data) displayed in the browser component 383 so that they are also visible to the non-browser component 385. Those skilled in the art will appreciate that in one illustrative embodiment, the properties and events may be detected from the browser component 383 using the Document Object Model (“DOM”) specification which details how objects in a web page (e.g., text, images, headers, links, etc.) are represented. The DOM specification also defines which attributes are associated with each object, and how the objects and attributes can be manipulated. In one embodiment, the non-browser component 385 uses a DOM to obtain information from attributes and events associated with downloaded web pages in the browser component 383 so that adjustments may be made to patient data and modifications made to device settings from within the non-browser component 385.

In particular and as briefly described above with respect to FIG. 1, the browser component 383 may be utilized to generate and display a web page for selecting and viewing patient data on a web site hosted by the web server 220 in the host 212. The non-browser component 385 may be utilized to display and modify the patient data received in the browser component 383 from the devices 202, 204, and 206 in the advanced patient management system. Via the GUI in the non-browser component 385, patient data gathered by the devices 202, 204, and 206 as well as settings for these devices may be displayed and modified by a user, as will be described more fully below in the description of FIG. 3.

Turning now to FIG. 2B, the browser component 383 is shown integrated into the non-browser component 385 in accordance with an alternative illustrative embodiment of the invention. In this embodiment, the non-browser component 385 may be a client application program which includes the browser component 383 for viewing patient data in a web page format. The non-browser component 385 also enables a user to view and modify patient data and device settings as briefly discussed above with respect to FIG. 2A and as described more fully below in the description of FIG. 3.

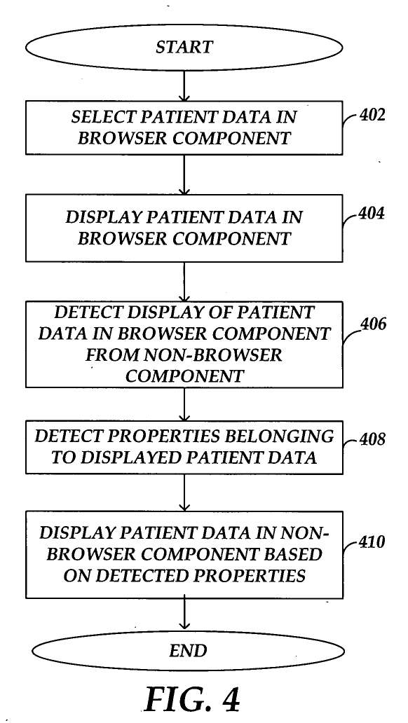

FIGS. 3-4 are flowcharts illustrating methods for enabling collaborative communication between the browser component 383 and the non-browser component 385 in the advanced patient management system of FIG. 1, according to one embodiment of the present invention. The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

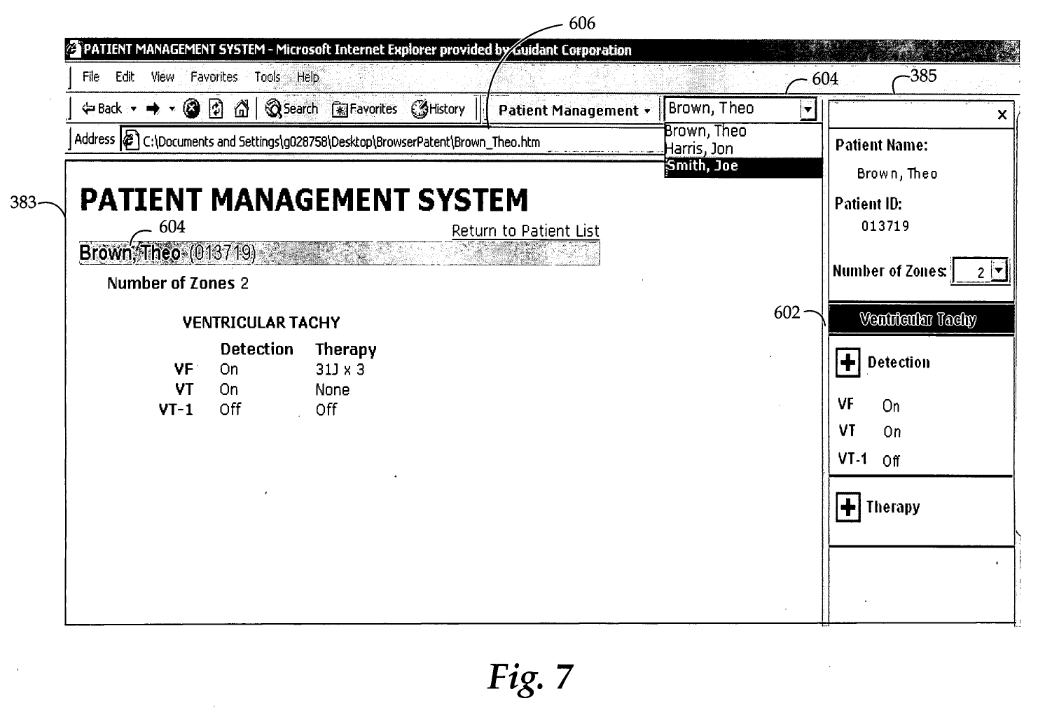

Referring now to FIG. 3, the logical operations begin at operation 302 where a user selects patient data in the non-browser component 385. In particular, and as shown in detail in FIG. 7, patient data 604 may be selected from a list from a dropdown box. Returning now to FIG. 3, once the patient data is selected at operation 302 the logical operations continue at operation 304 where the non-browser component 385 directs the browser component 383 to display the selected patient data. In particular, a user, through the non-browser component 385, may direct the browser component 383 to request the selected patient data from a server computer such as the host 312. For instance, as shown in FIG. 7, a user may select patient data for “Joe Smith” to be displayed in the browser component 383.

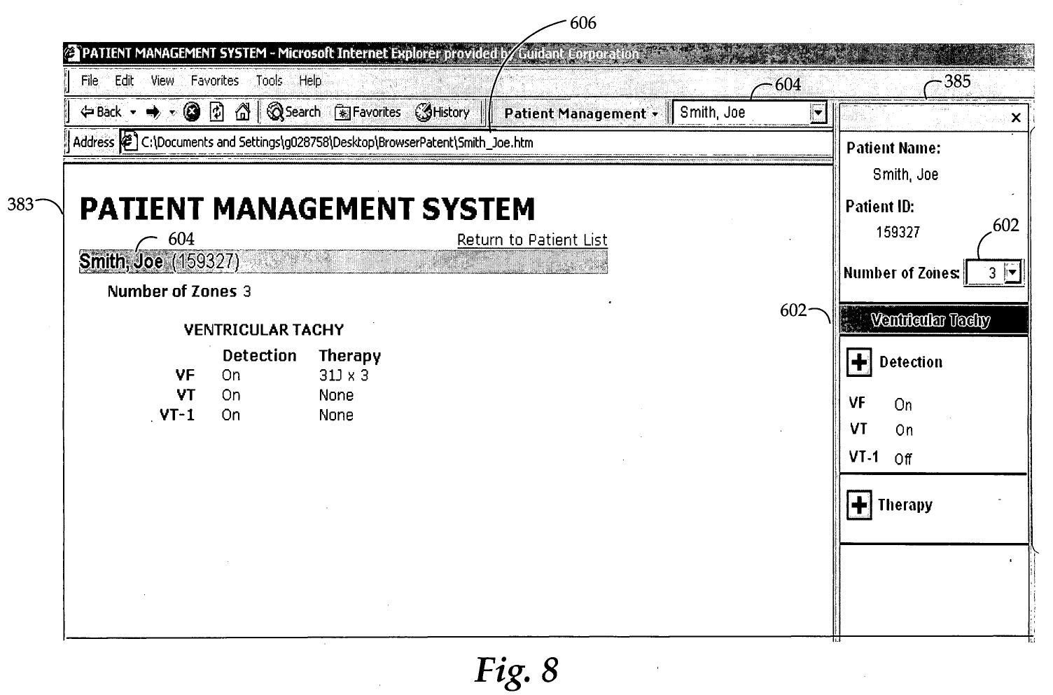

Returning now to FIG. 3, the logical operations then continue from operation 304 at operation 306 where the non-browser component 385 displays the patient data retrieved from the host 312 in the browser component 383. For instance, as shown in FIG. 8, the selected patient data 604 “Joe Smith” is now displayed in the browser component 383. Returning now to FIG. 3, the logical operations then continue from operation 306 at operation 308 where the non-browser component 385 retrieves patient data settings for the selected patient data and displays the patient data settings at operation 310. In particular, the non-browser component 385 may load current IMD device settings for the patient “Joe Smith” from the host device 212. The loaded device settings would replace any settings associated with currently displayed patient data in the non-browser component 385. For instance, as shown in FIGS. 7 and 8, the settings 602 for the patient data 604 have been updated for the currently displayed patient “Joe Smith” from the previously displayed patient “Theo Brown.”

Returning now to FIG. 3, the logical operations then continue from operation 310 at operation 312 where the non-browser component 385 receives modified patient data settings from a user. For instance, referring now to FIG. 8, a user may change the number of zones in the current patient data settings 602 for the patient “Joe Smith” from “3” to “1” as a result of information that the patient will only be in a particular zone (i.e., zone 1) for the next several hours. Returning now to FIG. 3, the logical operations then continue from operation 312 to operation 314 where the non-browser component 385 sends the modified patient data settings to the host 212. In particular, once the modified patient data settings are received at the host 212, the host 212 may deliver the modified settings to the ITU 208 for forwarding to the devices 202, 204, and 206 in the advanced patient management system 200. The logical operations then continue from operation 314 at operation 316 where the non-browser component 385 retrieves the modified patient data from the host 212 to be displayed in the browser component 383 at operation 318. The logical operations of FIG. 3 then end.

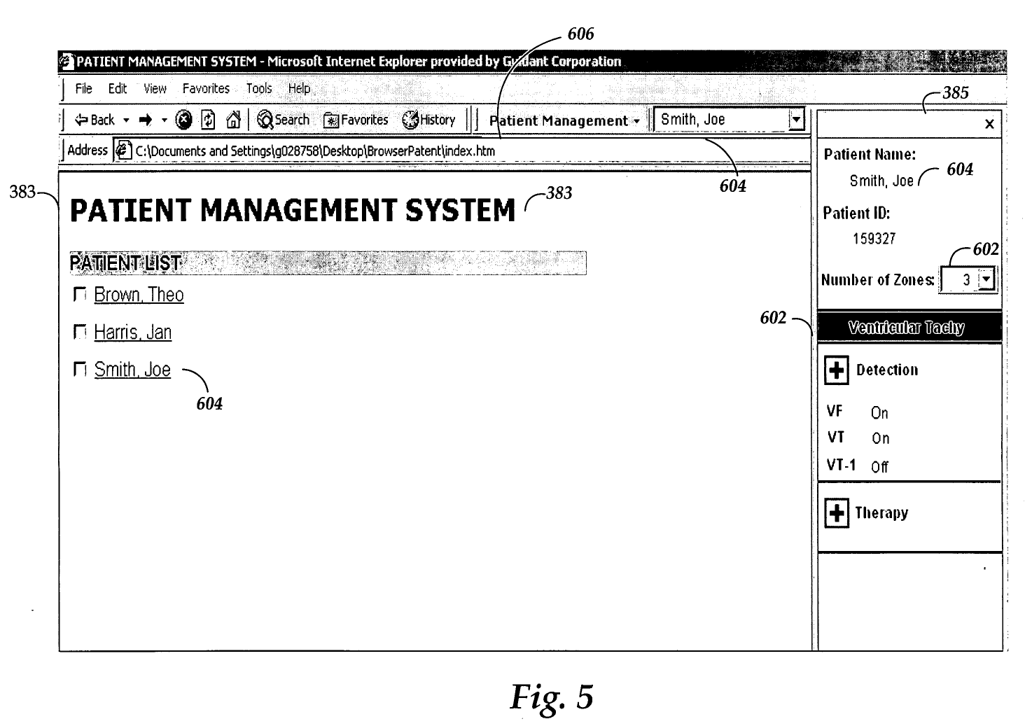

Referring now to FIG. 4, the logical operations begin at operation 402 where a user selects patient data in the browser component 383. In particular, and as shown in detail in FIG. 5, patient data 604 may be selected from a list displayed in a web page in the browser component 383. For instance, the web page in the browser component 383 may be downloaded from the host 212 by typing in a URL in the address box 606. Once the web page has been loaded into the browser component 383, the user may select a name from the displayed list of patient data to be displayed in the non-browser component 385.

Returning now to FIG. 4, once the patient data is selected at operation 402 the logical operations continue at operation 404 where the browser program 340 loads the patient data from the host 212 and displays the data in the browser component 383 as a web page. The logical operations then continue from operation 404 to operation 406 where the non-browser component 385 detects the display of the patient data in the browser component 338. In particular, non-browser component 385 may detect a “navigate complete” event reported by the browser component 383 when the patient data has been downloaded and displayed. After the non-browser component 385 detects the “navigate complete” event, the non-browser component 385, by using information contained in the URL of the served web page or by reading content within the web page (such as an XML tag), to detect a name or ID associated with the patient data in order to display the patient data.

The logical operations then continue from operation 406 to operation 408 where the non-browser component 385 detects properties belonging to the displayed patient data in the browser component 383. In particular, in addition to the displayed patient data, the patient data may also include properties and attributes not displayed in the browser component 383. These properties and attributes may include, in one illustrative embodiment, device settings associated with the displayed patient data. It should be understood that the non-displayed properties and attributes are exposed so that they are visible by the non-browser component 385 when the new patient data is downloaded into the browser component 383. It will be appreciated that in an alternative embodiment, the non-browser component 385 may detect a patient name displayed in the browser component 385 and then retrieve the properties associated with the detected patient name directly from the host 212.

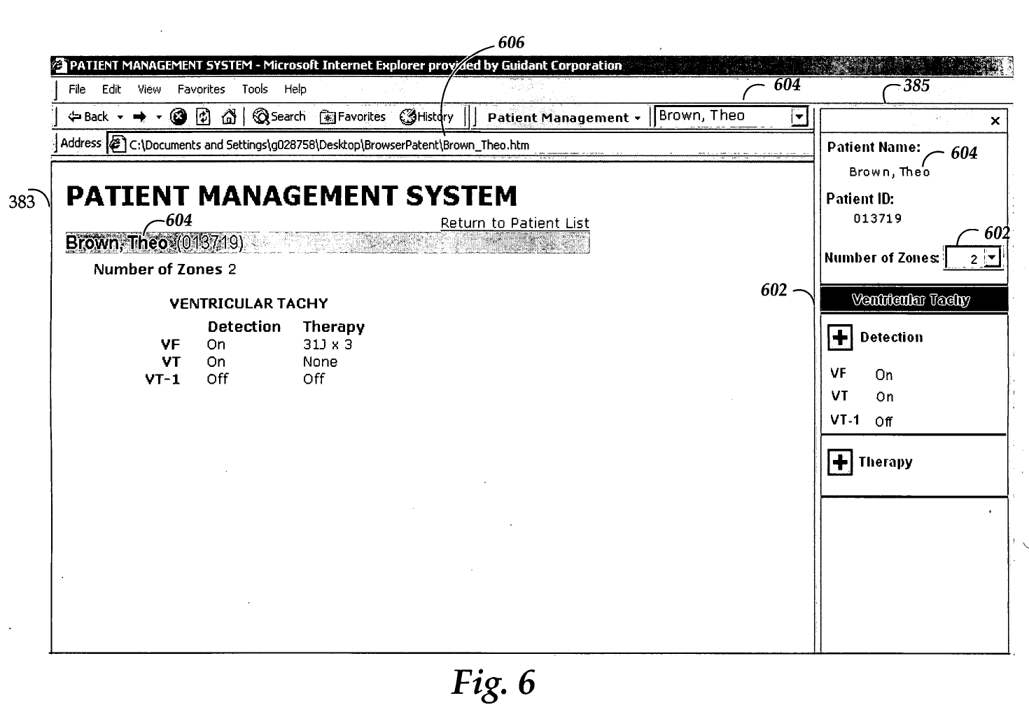

The logical operations then continue from operation 408 at operation 410 where the non-browser component 385 displays the detected patient data based on the propertied detected at operation 408. In particular, the non-browser component 385 uses the detected patient data and the detected properties to display the patient data and patient data settings. For instance, as shown in FIGS. 5 and 6, the patient data 604 for “Theo Brown” is loaded and displayed in the browser component 383. In one illustrative embodiment, the patient data is concurrently displayed in the non-browser component 385. The patient data settings 602 detected from the properties loaded into the browser component 383 are also displayed in the non-browser component 385 updating any previously displayed data. The logical operations of FIG. 4 then end.

Based upon the foregoing, it should be appreciated that the present invention provides a method and system for enabling collaborative communication between browser and non-browser components in an advanced patient management system. Although the invention has been described in language specific to computer structural features, methodological acts and by computer readable media, it is to be understood that the invention defined in the appended claims is not necessarily limited to the specific structures, acts or media described. Therefore, the specific structural features, acts and mediums are disclosed as exemplary embodiments implementing the claimed invention. Since many embodiments of the invention can be made without departing from the spirit and scope of the invention, the invention resides in the claims hereinafter appended.

What is claimed is:

1. A method for enabling collaborative communication between browser and non-browser components in an advanced patient management system comprising:
receiving, in the browser component, a selection of patient data from the advanced patient management system;
displaying, in the non-browser component, the patient data selected in the browser component;
receiving a selection of patient data from the advanced patient management system in the non-browser component; and
displaying, in the browser component, the patient data selected in the non-browser component.

2. The method of claim 1, further comprising:
receiving modified patient data in the non-browser component; and
displaying the modified patient data in the browser component.

3. The method of claim 2, wherein receiving modified patient data in the non-browser component comprises receiving modified settings associated with the patient data in the non-browser component, wherein the modified settings are associated with at least one patient monitoring device in the advanced patient management system.

4. The method of claim 1, wherein displaying, in the non-browser component, the patient data selected in the browser component comprises:
detecting, in the non-browser component, the patient data displayed in the browser component;
detecting, in the non-browser component, properties belonging to the displayed patient data in the browser component; and
displaying the patient data in the non-browser component based on the detected properties.

5. The method of claim 1, wherein displaying, in the browser component, the patient data selected in the non-browser component comprises receiving a command from the non-browser component to retrieve and display the selected patient data in the browser component.

6. The method of claim 1, wherein receiving a selection of patient data from the advanced patient management system in the non-browser component comprises receiving patient identification information.

7. The method of claim 1, wherein displaying, in the browser component, the patient data selected in the non-browser component comprises displaying the patient data in a web page generated by the browser component.

8. A system for enabling collaborative communication between components in an advanced patient management system comprising, comprising:
a central processing unit;
a memory; and
a non-browser component capable of executing on the central processing unit, wherein the non-browser component is in communication with a browser component and wherein the non-browser component is operative to:
receive patient data from the browser component;
display the received patient data from browser component;
receive a selection of patient data from the advanced patient management system; and
communicate the received patient data to the browser component for display in the browser component.

9. The system of claim 8, wherein the non-browser component is further operative to:
receive modified patient data; and
display the modified patient data in the browser component.

10. The system of claim 9, wherein the modified patient data comprises modified settings associated with the patient data, the modified settings associated with at least one patient monitoring device in the advanced patient management system.

11. The system of claim 9, wherein the non-browser component is further operative to:
detect the patient data displayed in the browser component;
detect settings associated with the patient data; and
display the settings with the detected patient data.

12. The system of claim 9, wherein the non-browser component is further operative to:
retrieve the selected patient data in the non-browser component from a server; and
display the selected patient data retrieved from the server in the browser component.

13. The system of claim 8, wherein the patient data comprises patient identification information.

14. The system of claim 8, wherein the browser component is a web browser.

15. The system of claim 8, wherein the non-browser component is a web browser plug-in module.

16. The system of claim 8, wherein the patient data is displayed in the browser component as a web page.

17. A computer-readable medium having computer-executable instructions which when executed on a computer, perform a method for enabling collaborative communication between browser and non-browser components in an advanced patient management system, the method comprising:
receiving, in the browser component, a selection of patient data from the advanced patient management system;
displaying, in the non-browser component, the patient data selected in the browser component;
receiving a selection of patient data from the advanced patient management system in the non-browser component; and
displaying, in the browser component, the patient data selected in the non-browser component.

18. The computer-readable medium of claim 17, further comprising:
receiving modified patient data in the non-browser component; and
displaying the modified patient data in the browser component.

19. The computer-readable medium of claim 18, wherein receiving modified patient data in the non-browser component comprises receiving modified settings associated with the patient data in the non-browser component, wherein the modified settings are associated with at least one patient monitoring device in the advanced patient management system.

20. The computer-readable medium of claim 17, wherein displaying, in the non-browser component, the patient data selected in the browser component comprises:
detecting, in the non-browser component, the patient data displayed in the browser component;
detecting, in the non-browser component, properties belonging to the displayed patient data in the browser component; and
displaying the patient data in the non-browser component based on the detected properties.

21. The computer-readable medium of claim 17, wherein displaying, in the browser component, the patient data selected in the non-browser component comprises receiving a command from the non-browser component to retrieve and display the selected patient data in the browser component.

22. The computer-readable medium of claim 17, wherein receiving a selection of patient data from the advanced patient management system in the non-browser component comprises receiving patient identification information.

23. The computer-readable medium of claim 17, wherein displaying, in the browser component, the patient data selected in the non-browser component comprises displaying the patient data in a web page generated by the browser component.
